(19) United States
(12) Patent Application Publication
(10) Pub. No.: US 2009/0274909 A1
(43) Pub. Date: Nov. 5, 2009

(54) Coated particle with shimmering appearance and engineered stone containing coated particles

(76) Inventors: Kevin Bergevin, Kingston (CA); Kimberley L. Reid, Napanee (CA); Jocelyn M. Willis-Papi, Kingston (CA)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/151,050

(22) Filed: May 2, 2008

(51) Int. Cl. B32B 1/00

(52) U.S. Cl. 428/406; 428/404

(57) ABSTRACT

A coated particle having a shimmering appearance to an observer contains a refractive particle, a transparent coating on the refractive particle, reflective particles and refractive particles embedded in the coating, with one of the reflective particles or the reflective particles primarily at a surface of the coating. Also an engineered stone has a shimmering appearance due to incorporation of coated particles.

### BACKGROUND OF THE INVENTION

1. Field of Invention

This invention is directed to a coated particle which has a shimmering appearance to an observer and to an engineered stone also having a shimmering appearance due to incorporation of coated particles.

2. Description of the Related Art

Engineered stone products may be produced by a well known procedure commercialized by Breton S.p.A. of Castello di Godego, Italy, so-called “Breton Stone”. In this technology, resin precursors are blended at low weight percentages with crushed stone aggregate to provide a relatively dry mass of material, distributed evenly on a support carrier, vibro-compacted under vacuum and then cured to yield a rigid product. A process used to practice this technology is disclosed by Toncelli in U.S. Pat. No. 4,698,010. Breton Stone materials are disclosed for use as flooring tile. Subsequent improvements to the technology, such as U.S. Pat. No. 6,387,985 to Wilkinson and Burchfield increased the uses of the material for general surfacing, particularly making it suitable for use as a countertop. Zodiaq® Quartz Surfacing from DuPont is an example of a commercially available engineered stone. Whether the product is floor tile or countertop, the slab produced by the Breton Stone process requires calibration to render it planar and uniform in thickness, as well as to reveal the aesthetic features of the product. This is followed by polishing to render the surface glossy.

As described in U.S. Pat. No. 6,387,985, materials may be added for a decorative effect. Decorative additives are distinguished from stone fillers primarily by the amount present in the composition. The crushed natural stone filler acts as an aggregate and is typically present in the a range from 85% to 95% by weight. Decorative additives such as gemstones, metal flake or filings, micas, seashells, pearls, colored or transparent polymeric particles, mirrored particles and pigments have been added in attempts to increase the visual appeal and aesthetic qualities of the engineered stone. However, these quantities typically have not exceeded about 5% by weight, and preferably, do not exceed 2% by weight. The decorative additives are thoroughly mixed with the other components during the blending, or placed on the surface subsequent to distribution on the support carrier and prior to vibro-compaction.

However a limiting factor in the incorporation of a decorative additive is due to contact with heavy aggregates during manufacture of the final article. Such aggregate can act to minimize or destroy the desired decorative effect of the additive.

There is a need for an additive which imparts a decorative appearance wherein the additive will remain intact during blending and compacting with heavy aggregates. Also there is a need for an additive which imparts a new visual appearance.

### SUMMARY OF THE INVENTION

The present invention is directed to a coated particle having a shimmering appearance to an observer comprising;

(a) a refractive particle;

(b) a coating on the refractive particle of (a);

(c) reflective particles embedded in the transparent coating of (b);

(d) refractive particles embedded in the transparent coating of (b);

with the proviso that the reflective particles of (c) or the refractive particles of (d) are primarily at a surface of the transparent coating.

Also the present invention is directed to an engineered stone containing coated particles.

### DETAILED DESCRIPTION OF PREFERRED EMBODIMENTS

A critical requirement in the present invention is visual in nature and more specifically the requirement is directed to a shimmering appearance which is present in a coated particle. Also the shimmering appearance is imparted by incorporation of the coated particles into an engineered stone.

As employed herein the word “shimmering” is used in its normal meaning, namely to shine with a tremulous or fitful light. “Tremulous” likewise is used in its normal meaning namely characterized by trembling or tremours.

### Transparent Particles

The first required component of the invention is a transparent particle which has the ability to refract light. The degree of transparency of the particle may vary; illustratively s translucent particle may be employed while in contrast an opaque particle is not suitable. Glass and transparent quartz are preferred materials for such particle.

The transparent particle which refracts light may vary in size. A particle having a size in a range from 10 mesh to 3 mesh is preferred, in order to have a large enough particle to demonstrate the shimmering effect, while not being too large such that the particle would not be able to pass through a manufacturing process without being fractured. A larger particle can be used with modification to the process parameters. The surface of the transparent particle can be planar, but curved and multifaceted surfaces are of more interest aesthetically in that they demonstrate more shimmering effect as the angle of observation changes. It is understood that both larger and smaller particles may be employed. However, generally at least 50% and more preferably 80% of the transparent, refractive particles will be present in the ranges set forth above in a final product of an engineered stone.

### Coating

A coating is applied to the transparent refractive particle which coating is needed to provide abrasion resistance. Also the coating serves as a binder to hold additional particles as will be more fully described below. A preferred coating comprises a polyester which typically prior to polymerization contains coupling agent and catalyst. An example of a suitable polyester coating is described in U.S. Pat. No. 3,278,662 and U.S. Pat. No. 5,321,055. Also an acrylic coating can be employed such as disclosed in U.S. Pat. No. 6,387,985. The coating prior to polymerization typically has a viscosity in a range from 1000 to 50,000 centipoise, preferably in the range from 15,000 to 40,000 centipoise to effectively coat the transparent refractive particle.

Polymerization, or “curing” of the coating can occur, as it is known to those skilled in the art, by chemical initiation, thermal or UV/Visible light, depending on the nature of the polymer with which the coating is formulated.

### Additives in Coating

In order to obtain the shimmering effect in the coated particle it is necessary to introduce appropriate additives in the coating. As a minimum, a first additive reflects light, while a second additive refracts light.

An example of an additive which reflects light is a metal (such as copper and brass) which also includes alloys. Additional examples include mica, holographic particles, metallized polyesters and reflective polymers including pearlescent and fluorescent pigments. Examples of a second additive which refract light are glass and transparent quartz.

The two additives which reflect or refract light will be in particle form and will be embedded within the coating. However, the refractive particles will be concentrated near the outer surface of the coating (i.e. the surface which does not contact the innermost transparent refractive particle to which the coating is applied). The concentration and size of the particles is not critical with the understanding that both concentration and size affect the desired shimmering appearance and it is necessary for the particles to be embedded within the transparent coating. Generally the reflective particles will be uniformly distributed within the coating. An example of a size for such particles is in a range from 1 micron to 3 millimeters. Generally the refractive particles need to be concentrated near the outer surface of the coating and will be smaller. An example of a size for such particle is in a range from 325 mesh to 34 mesh. In a preferred mode the refractive particle will be concentrated at the surface of the coating.

A further beneficial effect is present from the additive which is concentrated at the surface of the coated particle. Such benefit minimizes or eliminates agglomeration of coated particles since a number are formed at the same time.

In the above description it is understood that an individual particle can cause a color shift which is considered to be caused by a combination of refraction and reflection. Such color shift is within the scope of the present invention.

### Engineered Stone

The coated particles described above are incorporated into an engineered stone to provide the shimmering appearance in the stone. Such engineered stone is well known in the art and is specific to a naturally occurring mineral in combination with a binder and other additives. Typically the engineered stone contains 85 to 95% by weight mineral and the remainder binder (on a basis of mineral and binder). A preferred engineered stone contains quartz in the amount stated with binder such as polyester or acrylic. The binder may be the same binder as employed for the coating of the particles. The amount of coated particles to impart a shimmering effect is not critical but illustratively will be present in an amount of at least 5 percent by weight of the final composition.

The engineered stone is typically manufactured in the form of a slab. An advantage of the coated particle additive is an ability to withstand the weight and abrasion present in manufacture of the engineered stone. Such advantage includes an ability to be uniformly distributed in the engineered stone such that the shimmering appearance is present on different surfaces. Illustratively if the engineered stone is used as a kitchen countertop with an upper surface (i.e. the surface which does not face the floor) and side surfaces can have similar appearances.

### Manufacture

The coated particle is formed by applying the transparent coating to a reflective particle wherein prior to solidification of the coating both the reflective and refractive additives are present. The coated particle is added in formation of the engineered stone (which manufacture is well known such as set forth in the Background of the Invention). The coated particle is capable of being mixed into an abrasive mixture and undergoes vibration and compaction without loss of the coating which is needed for the shimmering effect.

The coated particle may be added at a later stage of the process to minimize abrasive contact. Typically, this latter addition would require the coated particle be hand placed on the surface of the uncured mix and compacted into the topmost portion of the mix. This is more labor intensive and less efficient. It will also result in coated particles present primarily on the topmost surface and leading to an uneven appearance along edge portions of the engineered stone.

Typically an engineered stone material is calibrated to remove surface material for uniformity and polished.

It is understood that conventional additives may be added to coated particles and/or the engineered stone composition.
The following examples are provided to further illustrate the present invention. All parts and percentages are by weight unless otherwise indicated.

### EXAMPLE 1

The following materials were used.
¼×8 Mesh Glass (Clear, Brown & Green)
30×50 Mesh Fine Crushed Clear Glass
Valspar Promoted Quartz Casting Resin 5766C00012 with approximately 25% Styrene
Luperox 26M50-peroxide
Silquest A-174-coupling agent
Siberline Silver Holograhic Flake GP 188SV

100 grams of resin were poured into a plastic container. 1 gram of both Luperox 26M50 and Silquest A-174 were added to the resin and stirred until well mixed. To this mixture, 5 grams of Silberline Silver Holographic Flake GP 188 SV was added and stirred until completely mixed.

¼×8 mesh glass of various colors (clear, or brown or green) were put into a 4 oz sample cup. This cup was filled approximately ⅓ to ½ full with the glass. A small amount of the resin mixture was added and stirred using a plastic stir rod followed by adding additional resin and stirring until all the glass in the cup was uniformly coated with the resin mixture(approximately 12-14% by weight of the binder resin). The resin coated glass particles were then transferred to a large strainer to allow for any excess resin mixture to drip off the glass. The resin coated glass particles were then transferred to a pail filled with the 30×50 mesh fine crushed clear glass. Using protective gloves with neoprene on the outside, the resin coated glass particles were stirred in the 30×50 mesh fine crushed clear glass. The process was repeated to obtain a quantity of resin coated particles having a further coating of 30×50 mesh fine crushed clear glass. Any excess of the 30×50 mesh fine crushed clear glass was removed by use of a sieve.

The resin and glass coated particles were evenly spread on a baking sheet and placed in an oven and the resin cured at 120 degrees Celsius for 45 minutes. Once cured, any remaining loose fine clear crushed glass was separated. The coated particles were placed in a bag and labeled. The above particles were then used in the engineered stone slab making process as follows;

Materials

| | | |
|---|---|---|
| 1.466 kg | Titanium Dioxide (Ti0₂) | pigment |
| 0.070 kg | Peroxide | catalyst |
| 6.400 kg | Valspar | resin |
| 0.104 kg | Silquest A-174 | silane coupling agent |
| 04.550 kg | Coated particles | additive |
| 13.410 kg | 10 mesh quartz | aggregate |
| 21.556 kg | 34 mesh quartz | aggregate |
| 7.900 kg | 84 mesh quartz | aggregate |
| 18.45 kg | 325 mesh quartz | aggregate |

The above materials were placed in a mixer and blended for 215 seconds. They were conveyed to a lay-down frame and distributed onto a support carrier. The support carrier with distributed mix was conveyed into a vibro-compacter and the materials were compacted. After vibro-compaction, the materials were conveyed into an oven and cured to form a slab of engineered stone. The engineered stone slab was polished with the final article having a desired decorative effect.

### EXAMPLE 2

The following materials were used
⅜×¼ mesh Clear Glass
Silverbond 325 mesh powder
84 mesh quartz
Valspar promoted quartz casting resin 5766C00012 with 19% styrene
Luperox 26M50 Peroxide
Silquest A-174 Coupling Agent
Sparkle Silvex 755-20-C Aluminum pigment
Afflair 600 Black Mica pigment.
   126 grams of resin was poured into a plastic container, 2.5 grams of both Luperox 26M50 and Silquest A-174 were added to the resin and stirred until mixed. To this mixture 6.5 grams of Sparkle Silvex 755-20-C Aluminum pigment and 3.1 grams of Afflair 600 Black Mica pigment was added and stirred until completely mixed.
   500 grams of ⅜×¼ mesh clear glass was put into a stainless steel bowl. A small amount of the resin mixture was added and stirred using the plastic stir rods. Adding resin mixture and stirring until all the glass in the cup was uniformly coated with the resin mixture. The coated glass particles were then transferred to a pail filled with Silverbond 325 mesh powder and 84 mesh Quartz. The coated glass particles were stirred around in the fines until coated. Repeating the above process until there is a quantity of coated particles in the fines. Once there were enough coated particles, the fines were poured through a sieve to separate the fines from the coated glass particles. The coated glass particles were evenly spread on a baking sheet and placed in the oven.
   Alternately, some particle were left in the particle fines and cured. The coated particles cured at 120 degrees Celsius for 45 minutes. Once cured any remaining loose fines were separated from the coated particles. The coated particles were placed in a bag and labeled.
   The above particles were then used in the engineered stone slab making process as follows;

Materials

| | | |
|---|---|---|
| 0.009 kg | Bayer Black 318M | pigment |
| 0.180 kg | Sparkle Silvex 755-20-C | pigment |
| 0.058 kg | Peroxide | catalyst |
| 2.890 kg | Valspar | redsin |
| 0.043 kg | Silquest A-174 | Silane coupling agent |
| 5.680 kg | Coated particles | additive |
| 8.285 kg | 10 mesh quartz | aggregate |
| 6.917 kg | 34 mesh quartz | aggregate |
| 2.605 kg | 84 mesh quartz | aggregate |
| 8.155 kg | 325 mesh quartz | aggregate |

The above materials were placed in a mixer and blended for 215 seconds. They were conveyed to a lay-down frame and distributed onto a support carrier. The support carrier with distributed mix was conveyed into a vibro-compacter and the materials were compacted. After vibro-compaction, the materials were conveyed into an oven and cured to form a slab of engineered stone. The engineered stone slab was polished with the final article having a desired decorative effect.

What is claimed is:

1. A coated particle having a shimmering appearance to an observer comprising:
(a) a refractive particle;
(b) a transparent coating on the refractive particle of (a);
(c) reflective particles embedded in the coating of (b);
(d) refractive particles embedded in the coating of (b);
with the proviso that the reflective particles of (c) or the refractive particles of (d) are primarily at a surface of the coating.

2. The coated particle of claim 1,
wherein the refractive particle of a has a size within a range from 10 mesh to 3 mesh.

3. The coated particle of claim 1,
wherein the refractive particles of (d) are primarily at the outer surface of the coating.

4. The coated particle of claim 3,
wherein the refractive particles of (d) have a size in a range form 325mesh to 34 mesh.

5. The coated particle of claim 1,
wherein at least a portion, the reflective particle of (c) have a size in a range from 1 micron to 3 millmeters.

6. The coated particle of claim 1,
wherein the refractive particle of (a) is glass.

7. The coated particle of claim 1,
wherein the transparent coating of (b) comprises a polyester containing polymer.

8. The coated particle of claim 1,
wherein the transparent coating of (b) comprises an acrylic containing polymer.

9. The coated particle of claim 1,
wherein the reflective particles of (c) are metal.

10. The coated particle of claim 1,
wherein the refractive particles of (d) are glass.

11. The coated particle of claim 1,
wherein (a) is glass, (b) comprises a polyester containing polymer, (c) is metal and (d) is glass.

12. An engineered stone sheet having a shimmering appearance to an observer comprising naturally occurring mineral in particle form and a binder,
wherein the sheet additionally contains a number of coated particles with each of the coated particles comprising:
(a) a refractive particle;
(b) a coating on the refractive particle of (a);
(c) reflective particles embedded in the coating of (b);
(d) refractive particles embedded in the coating of (b);
with the proviso that the reflective particles of (c) or the refractive particles of (d) are primarily at a surface of the coating.
